(19) United States
(12) Patent Application Publication
(10) Pub. No.: US 2009/0047178 A1
(43) Pub. Date: Feb. 19, 2009

(54) Automatic Biotesting Device

(75) Inventors: Andre Chojnacki, Saint-Gely du Fesc (FR); Jeanet Randrianarivo, Saint Martin de Londres (FR)

Correspondence Address: OLIFF & BERRIDGE, PLC, P.O. BOX 320850, ALEXANDRIA, VA, 22320-4850, US

(73) Assignee: MAXMAT SA, Grabels (FR)

(21) Appl. No.: 12/084,639

(22) PCT Filed: Nov. 9, 2006
(86) PCT No.: PCT/FR2006/002500

§ 371 Date: May 7, 2008

(30) Foreign Application Priority Data
Nov. 10, 2005 (FR) 0511479

(51) Int. Cl. G01N 35/02; G01N 35/10

(52) U.S. Cl. 422/65; 422/67

(57) ABSTRACT

The automatic immunological analysis apparatus comprises a plurality of bidirectional channels. Each channel is associated with a support carriage supporting reaction cups, moving along a corresponding guide rail according to predefined analysis protocols. The movement of each carriage is controlled independently on each channel. The apparatus comprises a distribution module, a washing module and a measuring module common to all the channels. The apparatus also comprises an independent incubation module for each channel and an independent agitation system associated with each support carriage of the cups.

### BACKGROUND OF THE INVENTION

The invention relates to an automatic biological apparatus, more particularly for immunological analysis, comprising at least one support carriage supporting a plurality of reaction cups, a distribution module, a washing module, a measuring module, incubation/agitating means and means for moving the support carriage according to predefined analysis protocols.

### STATE OF THE ART

In the biological analysis field, and more particularly that of immunology analyses, a conventional analysis apparatus generally comprises different working modules each associated with a step of a predefined analysis protocol.

The apparatus conventionally comprises support carriages of reaction cups moving from one module to the other, according to the analysis protocol. The apparatus comprises at least one distribution module designed to dispense the various reagents and samples in the reaction cups, an incubation/agitating module designed to condition the liquid present in the reaction cups, a washing module designed to separate the different reagents after reaction, and a measuring module performing the different measurements associated with the protocol.

To optimize the analysis throughput rate and to adapt to all types of protocols, two types of apparatus configurations exist. The first type of apparatus operates by batch and the second type of apparatus operates by random access.

The first method of running a batch consists in assigning all the reaction cups of the apparatus to the same protocol. The cups move in a group and pass at the same time successively in all the analysis modules of the apparatus. This type of apparatus is easy to program due to the simplicity of the protocol, and presents a good working rate.

However it is not possible to carry out several different protocols at the same time. It is necessary to wait until the end of a series to start another one. The apparatus is completely unsuitable for emergency measurements and does not enable the result rendering time to be optimized. The flexibility of such an apparatus is therefore very low.

The second method of proceeding by random access consists in performing a specific protocol for each reaction cup of the apparatus. Each cup is therefore completely independent from the adjacent cups. This results in all the modules of the apparatus being almost permanently available. Complicated computer management is necessary to arrange all the sequences of the protocols.

However, even if this method generates a real flexibility of use of the apparatus, the throughput rate of the latter is greatly reduced. Moreover, the computerized system controlling the apparatus is difficult to implement. This results in an exorbitant break-even cost.

### OBJECT OF THE INVENTION

The object of the invention is to remedy all the above-mentioned shortcomings and to provide an automatic biological analysis apparatus that is of simple design and enables a reasonable throughput rate combined with a real flexibility of use.

According to the invention, this object is achieved by the appended claims and more particularly by the fact that:
the apparatus comprises a plurality of bidirectional channels each associated with a predetermined number of reaction cups,
movement of the cups is controlled independently on each channel,
the distribution, washing and measuring modules are common to all the channels,
and each channel comprises independent incubation/agitating means.

### BRIEF DESCRIPTION OF THE DRAWINGS

Other advantages and features will become more clearly apparent from the following description of particular embodiments of the invention given as non-restrictive examples only and represented in the accompanying drawings, in which:

FIG. 1 schematically represents a perspective view of a particular analysis apparatus according to the invention.

FIGS. 2 and 3 respectively represent a perspective view and a top view of the apparatus according to FIG. 1, illustrating independent operation of the channels of the apparatus.

FIG. 4 represents an enlarged front view in cross-section along the line M of a support carriage of the apparatus according to FIGS. 1 to 3.

FIG. 5 is a side view of the carriage according to FIG. 4.

FIG. 6 represents an enlarged top view of a vibrating motor of the carriage according to FIGS. 4 and 5.

### DESCRIPTION OF PARTICULAR EMBODIMENTS

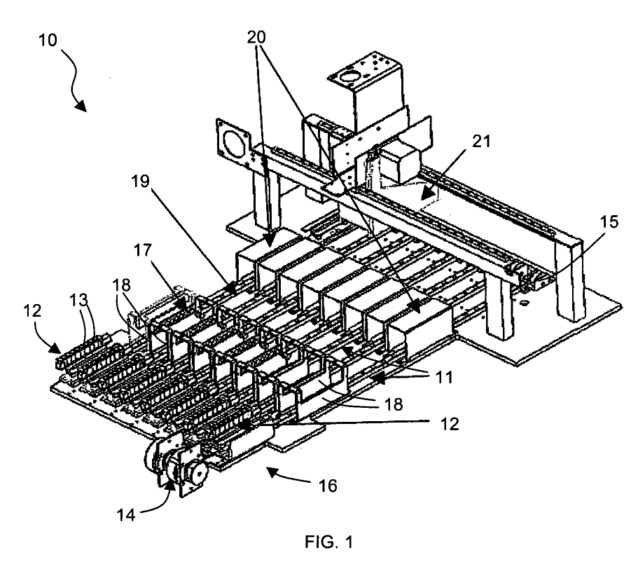

With reference to FIGS. 1 to 3, the automatic apparatus 10 is particularly deigned for immunology analysis. It is obvious that it can perform any other type of biological analysis.

Apparatus 10 is designed to perform analysis protocols, for example blood analyses, that may take from thirty minutes to several hours. Apparatus 10 is an apparatus commonly called an open apparatus, for its design enables any type of analysis protocol to be accepted, for optimum flexibility and throughput. Apparatus 10 also comprises a plurality of adjacent working modules each corresponding to a step of an analysis protocol to be carried out.

In FIGS. 1 to 3, apparatus 10 preferably comprises eight parallel guide rails 11 extending all along apparatus 10 and defining eight completely independent channels of apparatus 10, each corresponding to a predefined analysis protocol.

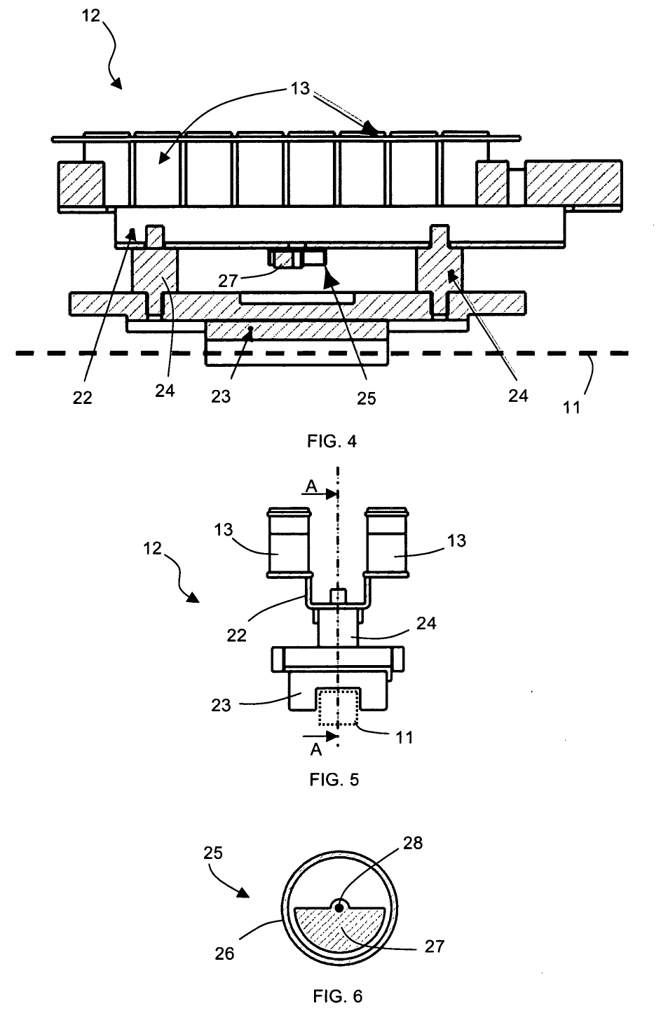

A support carriage 12 supporting reaction cups 13 is associated with each guide rail 11. Each carriage 12 preferably comprises sixteen reaction cups 13, i.e. two rows of eight cups 13 (FIGS. 4 and 5). Each carriage 12 is mounted with bidirectional sliding on corresponding guide rail 11. Each carriage 12 can move forwards or backwards along rail 11 that is associated therewith, according to the corresponding analysis protocol.

Each carriage 12 is controlled for example by a stepper motor 14 (FIG. 1) associated with one end of corresponding guide rail 11. Carriage 12 is mounted sliding on guide rail 11 by means for example of a pulley and belt system. In FIG. 1, a single stepper motor 14 is represented for the sake of clarity. It is obvious that each guide rail 11 can be connected to a stepper motor 14.

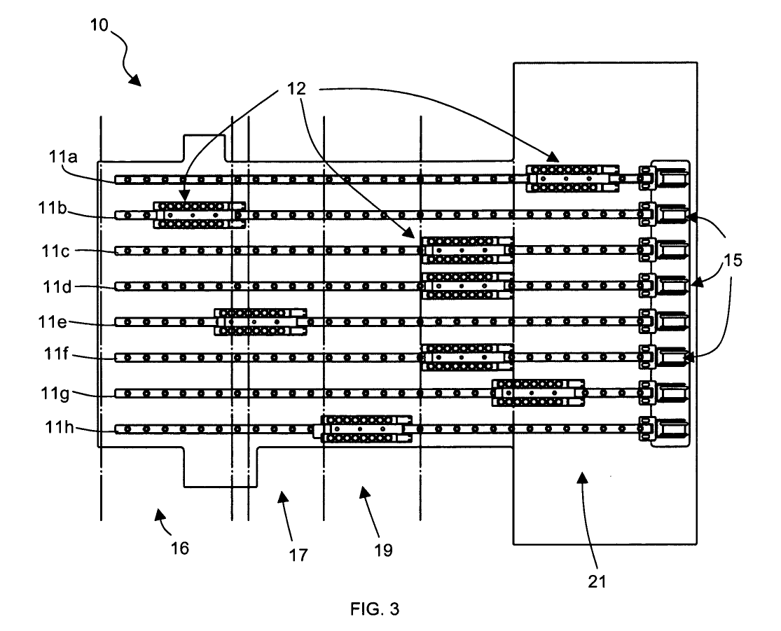

For example, each motor 14 drives a belt (not represented in FIGS. 1 to 3 for the sake of clarity) joined to corresponding carriage 12 and extending all along rail 11. The belt operates in conjunction with a pulley 15 (FIG. 3) arranged at the end of guide rail 11 opposite stepper motor 14.

Stepper motors 14 move support carriage 12 of cups 13 forwards or backwards to make the latter move from one module to the other of the apparatus.

Apparatus 10 preferably comprises a storage module 16 situated at one end of guide rails 11 and acting as loading and unloading zone of cups 13 of carriages 12. Storage module 16 is common to all the channels of apparatus 10.

Apparatus 10 comprises a washing module 17 common to all the channels of apparatus 10 and adjacent to storage module 16. In FIG. 1, washing module 17 comprises a distinct and independent washing chamber for each channel of apparatus 10 and a single washing head moving from one washing chamber to the other. Washing module 17 is in particular designed for separation of the different reagents present in cups 13.

For example, each chamber of washing module 17 comprises two lateral partitions 18 (FIG. 1) arranged on each side of corresponding guide rail 11, on which permanent magnets are arranged. In the case of use of magnetic balls as reagents inside cups 13, the permanent magnets attract the balls and prevent them being sucked up during the washing phase of cups 13.

Apparatus 10 also comprises a distribution module 19 common to all the channels of apparatus 10, adjacent to washing module 17 and performing dispensing of the various reagents and samples in cups 13 of carriages 12. In the particular case of a sample where the problem of contamination proves critical, apparatus 10 can comprise a use-once-only sampling cone system.

Furthermore, the reagent dispensing time and the rinsing time of cups 13 respectively associated with distribution module 19 and washing module 17 represent a time of less than one minute. A single distribution module 19 and a single washing module 17 are therefore sufficient to ensure a good throughput rate.

Apparatus 10 then comprises eight incubation modules 20 (FIG. 1) adjacent to distribution module 19 and each associated with a guide rail 11 and with corresponding support carriage 12 of cups 13. As represented in FIG. 1, each incubation module 20 for example comprises three partitions surrounding carriage 12, when it is positioned at the level of corresponding incubation module 20.

Each incubation module 20 ensures optimum temperature conditions for the corresponding channel of apparatus 10. This results in particular in an efficiency of reaction between the liquid and solid phases in each cup 13. Incubation modules 20 independent from apparatus 10 thereby optimize the flexibility of apparatus 10, which can therefore present different incubation characteristics on each of its channels.

Apparatus 10 finally comprises a measuring module 21 common to all the channels of apparatus 10 and adjacent to the different incubation modules 20. Measuring module 21 in particular performs quantitative measurement of the dosage to be made. This determination can be performed optically by photometry or, in the case of very sensitive analyses, by luminescence or fluorescence.

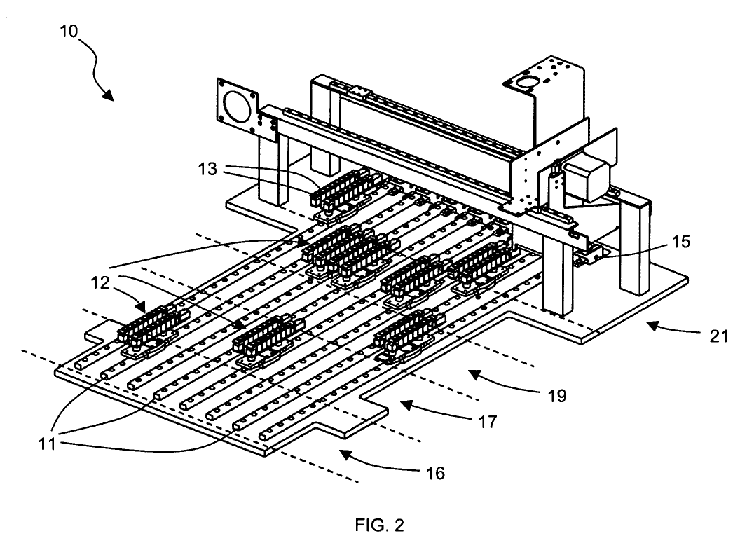

Measuring module 21 can comprise a single reading head moving above guide rails 11 by means of a portal beam. In FIG. 1, the reading head is in a first position at one end of the beam, whereas in FIG. 2, the reading head is in a second position at the other end of the beam. Single measuring module 21 enables a large gain in terms of cost to be made, as this type of module is very costly.

Storage module 16 of such an analysis apparatus 10 is optional. Washing module 17, distribution module 19 and measuring module 21 are common to all the channels of apparatus 10 and incubation modules 20 are independent for each channel of apparatus 10. In addition, each support carriage 12 of reaction cups 13 comprises independent agitating means, as described below.

In FIGS. 4 and 5, each support carriage 12 of reaction cups 13 comprises a support plate 22 mounted on an anti-vibration base 23 by means of two pads 24 made of flexible material. A vibrating motor 25 acting as vibration means associated with carriage 12 is fixed under plate 22, substantially in the centre of the latter (FIG. 4).

Base 23 slides on corresponding guide rail 11, support plate 22 is designed to hold the two rows of eight cups 13 and pads 24, preferably made of elastomer material, perform flexible fixing between plate 22 and base 23. Plate 22 is then agitated by the effect of vibrating motor 25 to transmit a characteristic movement to the liquid contained in cups 13, for example a rotation or vortex movement.

As represented in FIG. 5, anti-vibration base 23 presents a cross-section substantially in the form of an upside-down U operating in conjunction with guide rail 11. Support plate 22 presents a U-shaped cross-section the base of which is fixed to flexible material pads 24 and the branches of which are extended by two horizontal wings supporting cups 13. The latter are therefore positioned substantially on each side of guide rail 11.

In FIG. 6, vibrating motor 25 is for example an unbalanced motor of the mobile phone vibrator type. Motor 25 preferably comprises a hollow circular cage 26 inside which a rotating part 27 of semi-circular cross-section is mounted in rotation. Part 27 rotates around a vertical rotation axis 28 so as to generate the unbalance effect of motor 25.

Rotation of part 27 therefore acts as a forced oscillator driving plate 22 of carriage 12 with a characteristic movement enabling efficient mixing of the liquid contained inside cups 13. Rotation of part 27 is in particular designed to generate a vortex effect causing rotation of the liquid substantially in the form of a swirl.

Vibrating motor 25 can further comprise means for regulating the speed of rotation of rotating part 27, acting in particular on the agitation amplitude of corresponding plate 22. Each support carriage 12 of cups 13 thus adapts optimally to the characteristics proper to each protocol associated with the corresponding channel of apparatus 10.

For example, the speed of rotation of vibrating motor 25 is comprised between 300 rpm and 4000 rpm. It is thereby possible to make the volume or the viscosity of the liquid inside cups 13 vary.

Such agitating means associated with carriage 12 therefore present the advantage of being simple and light. They provide optimum stirring efficiency, in particular due to the large adjustment possibilities.

Furthermore, such an agitating system dissociated from incubation modules 20 of apparatus 10 means that agitation conditions proper to each carriage 12 of each channel of apparatus 10 can be had. This results in optimization of results and in particular in a good repeatability of the measurements.

Operation of apparatus 10 will be described in greater detail with regard to FIGS. 2 and 3. In FIGS. 2 and 3, partitions 18 of the different chambers of washing module 17, incubation modules 20 and stepper motors 14 are not represented for the sake of clarity.

Each channel of apparatus 10 comprises a support carriage 12 of cups 13 sliding along corresponding guide rail 11a to 11h (FIG. 3). In FIG. 3, carriage 12 sliding along guide rail 11a is at the level of measuring module 21. Carriages 12 of guide rails 11c, 11d and 11f are in their respective incubation module 20 (not represented in FIGS. 2 and 3 for the sake of clarity).

Each incubation module 20 is independent, so that carriages 12 are not subjected to the same incubation conditions. Moreover, agitation of carriages 12 by means in particular of vibrating motor 25 described above, takes place at the level of each incubation module 20, independently from incubation and in a manner proper to each carriage 12.

Carriage 12 associated with guide rail 11b is at the level of storage module 16, ready to enter the corresponding washing chamber of washing module 17. Carriage 12 associated with guide rail 11e enters the corresponding washing chamber of washing module 17. Carriage 12 associated with guide rail 11g is positioned between incubation module 20 and measuring module 21. Carriage 12 associated with guide rail 11h is at the level of distribution module 19.

Each channel of apparatus 10 is therefore completely independent, carriages 12 being able to be in different modules from one channel to the other at the same time. The modules used for the different protocols of each channel are the same for all the channels, but they are solicited in totally independent manner and with different parameters, in particular as far as the temperature and speed of agitation are concerned.

The flexibility of apparatus 10 is therefore great and apparatus 10 is easy to program, as each channel is completely independent with associated movement means that are also independent.

Such an analysis apparatus 10 as described above therefore enables a perfect optimization between a reasonable throughput rate and a great flexibility of use.

It is possible to assign any protocol to an available channel of the apparatus, while the others are still working, and also to dedicate one or more channels for specific treatments. As each carriage 12 comprises sixteen cups, sixteen analyses of the same protocol can therefore be performed on each channel of apparatus 10.

The congestion problem of a single incubation module is solved by the plurality of incubation modules 20 each operating in conjunction with a guide rail 11 of apparatus 10. Each channel can have specific measuring parameters, such as incubation temperatures and agitation speeds.

Apparatus 10 is moreover of very simple design and its final technical cost is low.

The invention is not limited to the different embodiments described above. The number of guide rails 11 and the number of cups 13 of each carriage 12 are non-restrictive. They can vary according to the general size of apparatus 10 or to the different applications of apparatus 10.

The positioning of the modules with respect to one another in apparatus 10 may be different. Apparatus 10 may comprise optional modules, so long as the incubation modules and agitating means of the carriages are independent for each channel of the apparatus.

Stepper motor 14 actuating each carriage 12 can be replaced by any other suitable drive means and can be placed indifferently at the ends of guide rails 11. Transmission by pulley and belt can be replaced by any other equivalent transmission means.

The general configuration of apparatus 10 can be different, so long as the channels of apparatus 10 remain parallel to one another. For example, apparatus 10 can present a substantially circular general shape, with channels forming concentric circles, or apparatus 10 can present any general shape, with channels able not to be straight.

1. An automatic biological apparatus comprising at least one support carriage supporting a plurality of reaction cups, a distribution module, a washing module, a measuring module, incubation/agitating means and means for moving the support carriage according to predefined analysis protocols, an apparatus wherein:
the apparatus comprises a plurality of bidirectional channels each associated with a predetermined number of reaction cups,
movement of the cups is controlled independently on each channel,
the distribution, washing and measuring modules are common to all the channels,
and each channel comprises independent incubation/agitating means.

2. The apparatus according to claim 1, wherein the incubation/agitation means associated with each channel comprise an independent incubation module associated with said channel, and agitation means associated with the support carriage of the cups which moves along a guide rail corresponding to said channel.

3. The apparatus according to claim 2, wherein the support carriage of the cups comprises a support plate mounted on an anti-vibration base by means of at least two pads made of flexible material, and a vibrating motor fixed under the plate.

4. The apparatus according to claim 3, wherein the vibrating motor is an unbalanced motor.

5. The apparatus according to claim 1, wherein the washing module comprises an independent washing chamber for each channel and a single washing head moving from one washing chamber to the other, each washing chamber comprising two lateral partitions which are arranged on permanent magnets.

6. The apparatus according to claim 1, wherein each channel is actuated by a stepper motor associated with said channel.

7. The apparatus according to claim 1, wherein one carriage supports two rows of eight cups on each channel.

8. The apparatus according to claim 1, comprising eight channels.
